(19) United States
(12) Patent Application Publication
(10) Pub. No.: US 2013/0229965 A1
(43) Pub. Date: Sep. 5, 2013

(54) PAGING DURING CONNECTED MODE DISCONTINUOUS RECEPTION (DRX) OPERATIONS

(71) Applicant: QUALCOMM INCORPORATED, San Diego, CA (US)

(72) Inventors: Dominique Francois Bressanelli, Eschborn (DE); Amit Mandil, Hyderabad (IN)

(73) Assignee: QUALCOMM INCORPORATED, San Diego, CA (US)

(21) Appl. No.: 13/781,269

(22) Filed: Feb. 28, 2013

(30) Foreign Application Priority Data
Mar. 5, 2012 (IN) 636/DEL/2012

(51) Int. Cl. H04W 52/02

(52) U.S. Cl. CPC H04W 52/0258
USPC 370/311

(57) ABSTRACT

Aspects of the present disclosure generally relate to wireless communications and, more particularly, to techniques for paging during Long Term Evolution (LTE) discontinuous reception (DRX) operations. Aspects generally include determining whether one or more paging occasions from a base station (BS) occur while a receiver of an apparatus is in an active state based on a discontinuous reception (DRX) cycle, adjusting a period that the receiver is in the active state during the DRX cycle if at least one paging occasion does not occur while the receiver is in the active state, and monitoring for at least one paging occasion occurring while the receiver is in the active state during the adjusted period.

### CROSS-REFERENCE TO RELATED APPLICATIONS

This application claims benefit of Indian Patent Application No. 636/DEL/2012, filed Mar. 5, 2012, which is herein incorporated by reference in its entirety.

### BACKGROUND

1. Field

Certain aspects of the present disclosure generally relate to wireless communications and, more particularly, to techniques for paging during Long Term Evolution (LTE) discontinuous reception (DRX) operations.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Mobile Telecommunications System (UMTS), a third generation (3G) mobile phone technology supported by the 3rd Generation Partnership Project (3GPP). UMTS includes a definition for a Radio Access Network (RAN), referred to as UMTS Terrestrial Radio Access Network (UTRAN). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications. For example, third-generation UMTS based on W-CDMA has been deployed all over the world. To ensure that this system remains competitive in the future, 3GPP began a project to define the long-term evolution of UMTS cellular technology. The specifications related to this effort are formally known as Evolved UMTS Terrestrial Radio Access (E-UTRA) and Evolved UMTS Terrestrial Radio Access Network (E-UTRAN), but are more commonly referred to by the project name Long Term Evolution, or LTE for short.

E-UTRAN is a RAN standard meant to be a replacement of the UMTS, High-Speed Downlink Packet Access (HSDPA) and High-Speed Uplink Packet Access (HSUPA) technologies specified in 3GPP release 5 and beyond. Unlike HSPA, LTE's E-UTRA is an entirely new air interface system, unrelated to and incompatible with W-CDMA. It provides higher data rates and lower latency and is optimized for packet data. E-UTRA uses orthogonal frequency-division multiple access (OFDMA) for the downlink and single-carrier frequency-division multiple access (SC-FDMA) on the uplink. In E-UTRAN, the protocol stack functions consist of the Media Access Control (MAC), Radio Link Control (RLC), Packet Data Convergence Protocol (PDCP), and Radio Resource Control (RRC) layers.

### SUMMARY

In an aspect of the disclosure, a method of wireless communication is provided. The method generally includes determining whether one or more paging occasions from a base station (BS) occur while a receiver of an apparatus is in an active state based on a discontinuous reception (DRX) cycle, adjusting a period that the receiver is in the active state during the DRX cycle if at least one paging occasion does not occur while the receiver is in the active state, and monitoring for at least one paging occasion occurring while the receiver is in the active state during the adjusted period.

In an aspect of the disclosure, an apparatus for wireless communication is provided. The apparatus generally includes means for determining whether one or more paging occasions from a base station (BS) occur while a receiver of an apparatus is in an active state based on a discontinuous reception (DRX) cycle, means for adjusting a period that the receiver is in the active state during the DRX cycle if at least one paging occasion does not occur while the receiver is in the active state, and means for monitoring for at least one paging occasion occurring while the receiver is in the active state during the adjusted period.

In an aspect of the disclosure, an apparatus for wireless communication is provided. The apparatus generally includes at least one processor configured to determine whether one or more paging occasions from a base station (BS) occur while a receiver of an apparatus is in an active state based on a discontinuous reception (DRX) cycle, adjust a period that the receiver is in the active state during the DRX cycle if at least one paging occasion does not occur while the receiver is in the active state, and monitor for at least one paging occasion occurring while the receiver is in the active state during the adjusted period. The apparatus also generally includes a memory coupled with the at least one processor.

In an aspect of the disclosure, a computer program product is provided. The computer program product generally includes a non-transitory computer readable medium having instructions stored thereon, the instructions executable by one or more processors for determining whether one or more paging occasions from a base station (BS) occur while a receiver of an apparatus is in an active state based on a discontinuous reception (DRX) cycle, adjusting a period that the receiver is in the active state during the DRX cycle if at least one paging occasion does not occur while the receiver is in the active state, and monitoring for at least one paging occasion occurring while the receiver is in the active state during the adjusted period.

Numerous other aspects are provided including apparatus and systems.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates an example wireless communication system according to certain aspects of the present disclosure.

FIG. 2 is a block diagram conceptually illustrating an example of an evolved Node B in communication with a user equipment (UE) in a wireless communication system, according to certain aspects of the present disclosure.

FIG. 3A illustrates a cycle that may be followed by a UE that is using a connected mode discontinuous reception (CDRX) method, according to certain aspects of the present disclosure.

FIG. 3B illustrates an adjusted cycle that may be followed by a UE that is using a CDRX method, according to certain aspects of the present disclosure.

FIG. 3C illustrates an adjusted cycle that may be followed by a UE that is using a CDRX method, according to certain aspects of the present disclosure.

FIG. 4 illustrates example operations for wireless communications, according to certain aspects of the present disclosure.

### DESCRIPTION

Techniques and apparatus are provided herein for paging during Long Term Evolution (LTE) discontinuous reception (DRX). In some embodiments provided herein, a user equipment (UE) in an active DRX mode monitors for paging occasions from a base station (BS) occurring during the active state duration. The UE monitors for paging occasions by decoding a physical downlink control channel (PDCCH) using a paging-radio network temporary identifier (P-RNTI) associated with a paging occasion unrelated to an international mobile subscriber identity (IMSI) associated with the UE. The UE may then adjust the duration of the active state if a paging occasion does not occur during the active state. Dynamically controlling the length of the DRX active state may reduce power consumption.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11 (WiFi), IEEE 802.16 (WiMAX), IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA) is a transmission technique that utilizes single carrier modulation at a transmitter side and frequency domain equalization at a receiver side. SC-FDMA has similar performance and essentially the same overall complexity as those of OFDMA. However, an SC-FDMA signal has lower peak-to-average power ratio (PAPR) because of its inherent single carrier structure. SC-FDMA has drawn great attention, especially in uplink communications where lower PAPR greatly benefits the mobile terminal in terms of transmit power efficiency. It is currently a working assumption for uplink multiple access scheme in 3GPP LTE, LTE-A, and E-UTRA.

### AN EXAMPLE WIRELESS COMMUNICATION SYSTEM

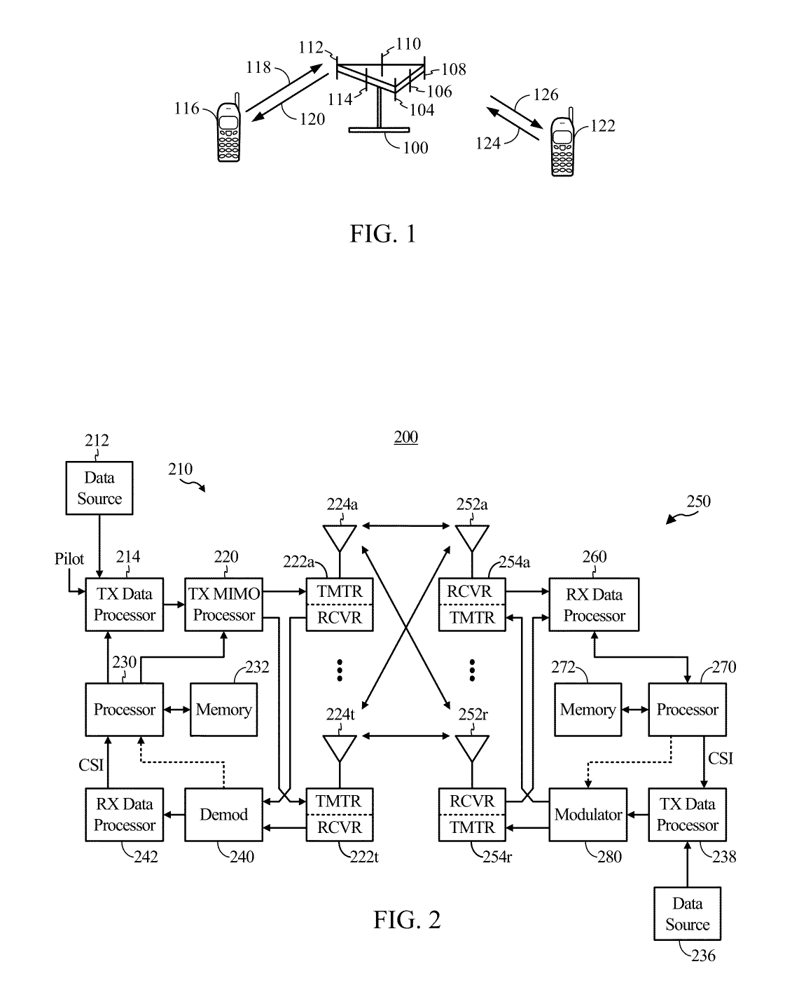

Referring to FIG. 1, a multiple access wireless communication system according to one aspect is illustrated. An access point 100 (AP) includes multiple antenna groups, one including antenna 104 and antenna 106, another including antenna 108 and antenna 110, and yet another including antenna 112 and antenna 114. In FIG. 1, only two antennas are shown for each antenna group; however, more or fewer antennas may be utilized for each antenna group. Access terminal 116 (AT) is in communication with antennas 112 and 114, where antennas 112 and 114 transmit information to access terminal 116 over forward link 120 (also known as a downlink) and receive information from access terminal 116 over reverse link 118 (also known as an uplink). Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124, and 126 may use different frequencies for communication. For example, forward link 120 may use a different frequency then that used by reverse link 118.

Each group of antennas and/or the area in which they are designed to communicate is often referred to as a sector of the access point. In an aspect, antenna groups each are designed to communicate to access terminals in a sector, of the areas covered by the access point 100.

In communication over forward links 120 and 126, the transmitting antennas of the access point 100 utilize beamforming in order to increase the signal-to-noise ratio (SNR) of forward links for the different access terminals 116 and 122. Also, an access point using beamforming to transmit to access terminals scattered randomly through the access point's coverage area causes less interference to access terminals in neighboring cells than an access point transmitting through a single antenna to all the access point's access terminals.

An access point (AP) may be a fixed station used for communicating with the terminals and may also be referred to as a base station (BS), a Node B, an evolved Node B (eNB), or some other terminology. An access terminal may also be called a mobile station (MS), user equipment (UE), a wireless communication device, terminal, user terminal (UT), or some other terminology.

FIG. 2 is a block diagram of an aspect of a transmitter system 210 (e.g., also known as an access point) and a receiver system 250 (e.g., also known as an access terminal) in wireless communication system 200, such as a MIMO system. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH), which is a downlink (DL) channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several MTCHs. Generally, after establishing a Radio Resource Control (RRC) connection, this channel is only used by UEs that receive MBMS (Note: old MCCH+MSCH). Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and uplink (UL). DL Transport Channels comprise a Broadcast Channel (BCH), Downlink Shared Data Channel (DL-SDCH), and a Paging Channel (PCH), the PCH for support of UE power saving (DRX cycle is indicated by the network to the UE), broadcasted over entire cell and mapped to physical layer (PHY) resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

The DL PHY channels, for example, comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels, for example, comprise:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C—Control

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U—User

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

### EXAMPLE DRX MODE OPERATIONS

With the ever-increasing popularity of smart phones, there are many new challenges for the design of wireless systems, including power consumption and signaling demands. For example, instead of being awake only for the typically small percentage of talk time, smart phones are awake much more often. Applications, such as e-mail or social networking, may send “keep-alive” message every 20 to 30 minutes, for example. Such applications often use many small and bursty data transmissions that may entail a significantly larger amount of control signaling. Some system level evaluations have identified control channel limitations in addition to traffic channel limitations.

Discontinuous Reception (DRX) is a method used in mobile communication to reduce power consumption, thereby conserving the battery of the mobile device. The mobile device and the network negotiate phases in which data transfer occurs, where the mobile device's receiver is turned on (e.g., in a connected state). During other times, the mobile device turns its receiver off and enters a low power state. There is usually a function designed into the protocol for this purpose. For example, the transmission may be structured in slots with headers containing address details so that devices may listen to these headers in each slot to decide whether the transmission is relevant to the devices or not. In this case, the receiver may only be active at the beginning of each slot to receive the header, conserving battery life. Other DRX techniques include polling, whereby the device is placed into standby for a given amount of time and then a beacon is sent by the base station periodically to indicate if there is any data waiting for it.

In LTE, DRX is controlled by the RRC protocol. RRC signaling sets a cycle where the UE's receiver is operational for a certain period, typically when all the scheduling and paging information is transmitted. The serving evolved Node B (eNB) may know that the UE's receiver is completely turned off and is not able to receive anything. Except when in DRX, the UE's receiver may most likely be active to monitor a Physical Downlink Control CHannel (PDCCH) to identify downlink data. During DRX, the UE's receiver may be turned off. In LTE, DRX also applies to the RRC_Idle state with a longer cycle time than active mode.

There are two RRC states for a UE: (1) RRC_Idle where the radio is not active, but an identifier (ID) is assigned to the UE and tracked by the network; and (2) RRC_Connected with active radio operation having context in the eNB.

In active mode, there is a dynamic transition between long DRX and short DRX. Long DRX has a longer “off” duration. Durations for long and short DRX are configured by the RRC protocol. The transition is determined by the eNB (e.g., with MAC commands) or by the UE based on an inactivity timer. For example, a lower duty cycle may be used during a pause in speaking during a voice over Internet protocol (VOIP) call; packets are arriving at a lower rate, so the UE can remain off for a longer period. When speaking resumes, this results in lower latency. Packets are arriving more often, so the DRX interval is reduced during this period.

### Paging During Connected Mode DRX Operations

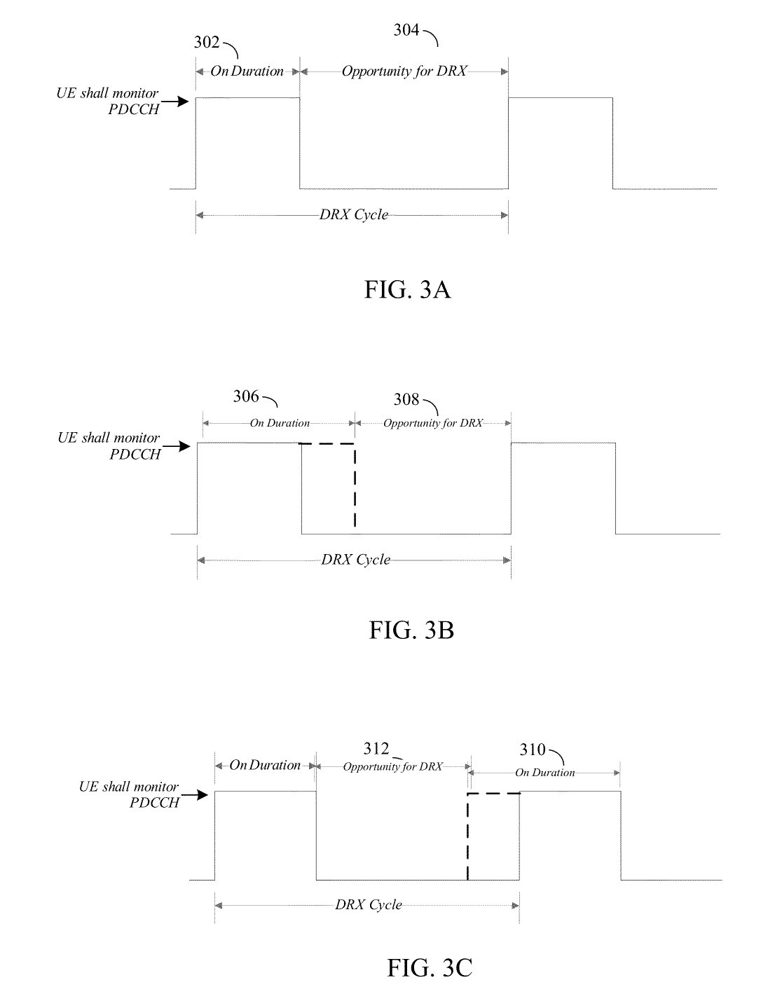

FIG. 3A illustrates a cycle that may be followed by a UE that is using a connected mode DRX (CDRX) method, according to certain aspects of the present disclosure. The UE may monitor its own paging occurrence based on a universal subscriber identity module (USIM) international mobile subscriber identity (IMSI) that is unique to the UE. In the case of CDRX, the UE may be allocated an ON duration 302 during which the UE may monitor downlink transmissions such as PDCCH. Outside of the ON duration, the UE may go to sleep mode 304 (opportunity for DRX) for battery saving or to acquire an inter-frequency/inter-radio access technology (RAT) neighbor cell identity if requested by the network to do so and report cell global identity. This mechanism may be used in particular for automatic neighbor cell discovery and automatic neighbor relation within the network where each eNB may update its neighbor list automatically once new cells are added in the network.

If a paging occurrence takes place while the UE is in an inactive state 304 based on a periodic DRX cycle (e.g., a sleep mode based on the IMSI associated with the UE), the UE may need to wake up if, in fact, the UE was sleeping and, as a result, there may be a cost in terms of battery consumption. In the scenario when the UE may be attempting to acquire a neighbor cell identity, the DRX cycle may be split into two different parts, and each part may not be long enough for neighbor system information acquisition even though the total DRX time may be long enough to guarantee acquisition if not split. An eNB engaged in an active call with the UE may be unaware of the IMSI associated with the UE. Therefore, the eNB may not be able to select a CDRX long cycle offset such that the UE paging occasion would fall within ON Duration period 302. Therefore, certain aspects of the present disclosure provide techniques for ensuring that the UE using a CDRX method may not have to awake from sleep mode if a paging occurrence takes place.

Paging in connected mode may have at least two purposes: to inform the UE of a pending change of system information and to indicate whether an earthquake and tsunami warning system (ETWS) and/or commercial mobile alert system (CMAS) notification is present or not. In both scenarios, the eNB may send paging information in all possible paging occasions since the eNB may not have knowledge of which IMSIs are camped under its coverage. In other words, the eNB may be expected to send paging in all system frame numbers (SFNs) and all subframes which correspond to a possible value of Ns=max(1,nB/T) as defined in 3GPP 36.304.

As the UE may need to monitor its own paging occasion in IDLE mode (e.g., sleep mode 304), any paging occasion may be appropriate for the UE in CONNECTED mode (e.g., ON duration 302) for the purposes described above (e.g., to inform the UE of a pending change of system information or to inform of any emergency situation). In other words, instead of monitoring its own paging occasion, the UE may monitor any paging occurrence during the ON duration 302 (or close to the ON duration 302 in case the ON duration 302 is less than the frequency of a paging occasion). As long as the UE monitors a paging occasion at least once every default Paging Cycle (e.g., 1.28 s), the UE may be compliant to 3GPP 36.331 performance requirements.

FIGS. 3A-C illustrate scenarios where periods that a UE is in active state may be adjusted to monitor for a paging occasion, according to certain aspects of the present disclosure. Referring to FIG. 3A, if a paging occasion subframe 302 is within the ON duration period, the UE may monitor paging in the paging occasion subframe 302 at least every default paging cycle (e.g., 1.28 s). In other words, the UE may attempt to decode PDCCH using P-RNTI in this sub-frame unrelated to the IMSI associated with the UE. Therefore, the UE may not have to awake for paging occasion subframe 304 if the UE is within the default paging cycle that begins at the paging occasion subframe 302. For certain aspects, paging occasion subframe 302 may be subframe 9 for FDD.

If the ON duration is less than the frequency of the paging occasion (e.g., 10 subframes; 10 ms), the UE may adjust the ON duration at least once every default paging cycle so that the paging occasion subframe may be monitored. Referring to FIG. 3B, the ON duration may be extended, as indicated by 308 to monitor for paging occasion subframe 306. As another example, referring to FIG. 3C, the ON duration may be extended to include subframes 312 before the original ON duration (in case of early wakeup for CQI/RI reporting) to monitor for paging occasion subframe 510. In aspects, the ON duration for two different default paging cycles may be extended as shown in FIGS. 3B and 3C, respectively.

If the CDRX long cycle length is greater than the default paging cycle, the UE may have to monitor multiple paging occasion subframes within the CDRX cycle. In other words, the UE may be required to monitor paging subframes corresponding to the paging subframe monitored during or near ON duration (e.g., the first paging occasion subframe) and paging subframes corresponding to the product of k and the default paging cycle, for k=1, 2, . . . n. In other words, as long as

first paging subframe+k*defaultPagingCycle<CDRX long cycle length,

the additional k paging subframes may be monitored. In this manner, the UE may leave an inactive state (e.g., during the Opportunity for DRX) to monitor a paging occasion at least once every default, or predefined, Paging Cycle. However, the amount of time the UE is not in the ON Duration may be increased and/or optimized.

Adjusting the ON duration to monitor for paging occasions may provide a longer battery life as the UE may not have to wake up outside of the CDRX ON duration to monitor paging channel once every defaultPagingCycle. Moreover, adjusting the ON duration may provide a faster inter-frequency/inter-RAT neighbor cell identity acquisition because the idle time within a connected mode DRX cycle may not be interrupted by monitoring the LTE paging occurrence. In other words, more time may be spent on the inter-frequency/inter-RAT cell frequency in order to acquire the set of system information needed for Cell Global Identification reporting.

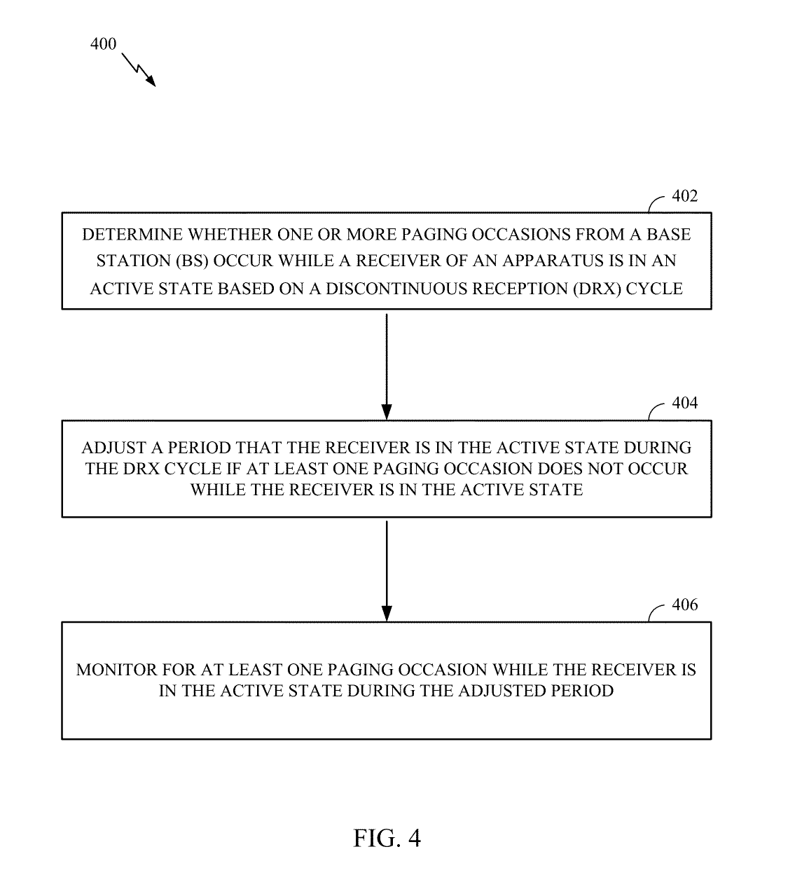

FIG. 4 illustrates example operations 400 for wireless communications, according to certain aspects of the present disclosure. The operations 400 may begin at 402 by determining whether one or more paging occasions from a base station (BS) occur while a receiver of an apparatus is in an active state based on a discontinuous reception (DRX) cycle. At 404, a period that the receiver is in the active state during the DRX cycle is adjusted if at least one paging occasion does not occur while the receiver is in the active state. At 406, at least one paging occasion occurring while the receiver is in the active state during the adjusted period is monitored for.

As used herein, a phrase referring to “at least one of a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the figures, those operations may have corresponding counterpart means-plus-function components with similar numbering.

More particularly, means for transmitting, means for sending, or means for forwarding may comprise a transmitter, such as the transmitter 254 illustrated in FIG. 2. Means for receiving may comprise a receiver, such as the receiver 254 illustrated in FIG. 2. Means for determining, means for processing, means for operating, means for detecting, means for performing, or means for transitioning may comprise a processing system having at least one processor, such as the processor 270 illustrated in FIG. 2. Means for storing may comprise a memory, such as the memory 272 of FIG. 2.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for wireless communications, comprising:
determining whether one or more paging occasions from a base station (BS) occur while a receiver of an apparatus is in an active state based on a discontinuous reception (DRX) cycle;
adjusting a period that the receiver is in the active state during the DRX cycle if at least one paging occasion does not occur while the receiver is in the active state; and
monitoring for at least one paging occasion occurring while the receiver is in the active state during the adjusted period.

2. The method of claim 1, wherein the adjusting comprises extending the period that the receiver is in the active state.

3. The method of claim 1, wherein the monitoring comprises decoding a physical downlink control channel (PDCCH) using a paging-radio network temporary identifier (P-RNTI) unrelated to an international mobile subscriber identity (IMSI) associated with the apparatus.

4. The method of claim 1, wherein the paging occasions from the BS follows a first periodic cycle.

5. The method of claim 4, wherein the receiver of the apparatus monitors for a paging occasion at least once every second periodic cycle.

6. The method of claim 5, wherein the DRX cycle is greater than the second periodic cycle.

7. The method of claim 5, further comprising:
determining whether the second periodic cycle is greater than the first periodic cycle; and
if the second periodic cycle is greater than the first periodic cycle, wherein the monitoring comprises monitoring for multiple paging occasions that occur while the receiver is in the active state.

8. The method of claim 1, further comprising leaving an inactive state by the receiver of the apparatus to monitor for a paging occasion.

9. The method of claim 8, wherein the DRX cycle is a long DRX cycle.

10. An apparatus for wireless communications, comprising:
means for determining whether one or more paging occasions from a base station (BS) occur while a receiver of an apparatus is in an active state based on a discontinuous reception (DRX) cycle;
means for adjusting a period that the receiver is in the active state during the DRX cycle if at least one paging occasion does not occur while the receiver is in the active state; and
means for monitoring for at least one paging occasion occurring while the receiver is in the active state during the adjusted period.

11. The apparatus of claim 10, wherein the adjusting comprises extending the period that the receiver is in the active state.

12. The apparatus of claim 10, wherein the monitoring comprises decoding a physical downlink control channel (PDCCH) using a paging-radio network temporary identifier (P-RNTI) unrelated to an international mobile subscriber identity (IMSI) associated with the apparatus.

13. The apparatus of claim 10, wherein the paging occasions from the BS follows a first periodic cycle.

14. The apparatus of claim 13, wherein the receiver of the apparatus monitors for a paging occasion at least once every second periodic cycle.

15. The apparatus of claim 14, wherein the DRX cycle is greater than the second periodic cycle.

16. The apparatus of claim 14, further comprising:
means for determining whether the second periodic cycle is greater than the first periodic cycle; and
if the second periodic cycle is greater than the first periodic cycle, wherein the monitoring comprises monitoring for multiple paging occasions that occur while the receiver is in the active state.

17. The apparatus of claim 10, further comprising means causing a receiver of the apparatus to leave an inactive state to monitor for a paging occasion.

18. The apparatus of claim 17, wherein the DRX cycle is a long DRX cycle.

19. An apparatus for wireless communications, comprising:
at least one processor configured to:
determine whether one or more paging occasions from a base station (BS) occur while a receiver of an apparatus is in an active state based on a discontinuous reception (DRX) cycle;
adjust a period that the receiver is in the active state during the DRX cycle if at least one paging occasion does not occur while the receiver is in the active state; and
monitor for at least one paging occasion occurring while the receiver is in the active state during the adjusted period; and
a memory coupled with the at least one processor.

20. The apparatus of claim 19, wherein the adjusting comprises extending the period that the receiver is in the active state.

21. The apparatus of claim 19, wherein the monitoring comprises decoding a physical downlink control channel (PDCCH) using a paging-radio network temporary identifier (P-RNTI) unrelated to an international mobile subscriber identity (IMSI) associated with the apparatus.

22. The apparatus of claim 19, wherein the paging occasions from the BS follows a first periodic cycle.

23. The apparatus of claim 22, wherein the receiver of the apparatus monitors for a paging occasion at least once every second periodic cycle.

24. The apparatus of claim 23, wherein the DRX cycle is greater than the second periodic cycle.

25. The apparatus of claim 23, wherein the at least one processor is further configured to:
determine whether the second periodic cycle is greater than the first periodic cycle; and
if the second periodic cycle is greater than the first periodic cycle, wherein the monitoring comprises monitoring for multiple paging occasions that occur while the receiver is in the active state.

26. The apparatus of claim 19, wherein the at least one processor is further configured to cause the receiver of the apparatus to leave an inactive state to monitor for a paging occasion.

27. The apparatus of claim 19, wherein the DRX cycle is a long DRX cycle.

28. A computer program product comprising a non-transitory computer readable medium having instructions stored thereon, the instructions executable by one or more processors for:
determining whether one or more paging occasions from a base station (BS) occur while a receiver of an apparatus is in an active state based on a discontinuous reception (DRX) cycle;
adjusting a period that the receiver is in the active state during the DRX cycle if at least one paging occasion does not occur while the receiver is in the active state; and
monitoring for at least one paging occasion occurring while the receiver is in the active state during the adjusted period.

29. The computer program product of claim 28, wherein the adjusting comprises extending the period that the receiver is in the active state.

30. The computer program product of claim 28, wherein the monitoring comprises decoding a physical downlink control channel (PDCCH) using a paging-radio network temporary identifier (P-RNTI) unrelated to an international mobile subscriber identity (IMSI) associated with the apparatus.

31. The computer program product of claim 28, wherein the paging occasions from the BS follows a first periodic cycle.

32. The computer program product of claim 31, wherein the receiver of the apparatus monitors for a paging occasion at least once every second periodic cycle.

33. The computer program product of claim 32, wherein the DRX cycle is greater than the second periodic cycle.

34. The computer program product of claim 32, wherein the instructions further executable by one or more processors for:
determining whether the second periodic cycle is greater than the first periodic cycle; and
if the second periodic cycle is greater than the first periodic cycle, wherein the monitoring comprises monitoring for multiple paging occasions that occur while the receiver is in the active state.

35. The computer program product of claim 28, wherein the instructions further executable by one or more processors for causing the receiver of the apparatus to leave an inactive state to monitor for a paging occasion.

36. The computer program product of claim 28, wherein the DRX cycle is a long DRX cycle.
